(19) United States
(12) Patent Application Publication
(10) Pub. No.: US 2026/0213298 A1
(43) Pub. Date: Jul. 23, 2026

(54) HEAT EXCHANGER AND METHOD THEREFOR

(71) Applicant: Sogefi Air & Cooling, Guyancourt (FR)

(72) Inventor: Stephen Thompson, Montreal (CA)

(21) Appl. No.: 19/140,876

(22) PCT Filed: Dec. 14, 2023
(86) PCT No.: PCT/IB2023/062711

§ 371 Date: Jun. 18, 2025

(30) Foreign Application Priority Data
Dec. 22, 2022 (FR) FR2214209

(51) Int. Cl. H01M 10/6556; B21D 53/04; B23P 15/26; H01M 10/625

(52) U.S. Cl. CPC H01M 10/6556; B21D 53/045; B23P 15/26; H01M 10/625; H01M 2220/20

(57) ABSTRACT

A heat exchanger (10) for a battery housing comprising a first panel (12), a second panel (14), and a plurality of cooling fluid circulation channels (16) therebetween. The first panel has an exterior surface (18) and a channel surface (20) opposite the exterior surface. The second panel has a cooling surface (22) and an abutment surface (24) opposite the cooling surface, and is welded to the first panel via a network of channel seams. The plurality of cooling fluid circulation channels are defined by the channel surface and the abutment surface. Each of the plurality of cooling fluid circulation channels are disposed between a first and a second channel seam (26a,26b) and define a central flow cavity (28) that narrows into a first and a second crevice (30a,30b). Each of the first and the second crevice has a length (L) and a width (W), and L²/W that is less than 250.

### FIELD OF THE DISCLOSURE

The present disclosure relates to a heat exchanger for a battery housing.

### BACKGROUND

Batteries for electric vehicles (EVs) are typically enclosed in a battery housing and located on the underside of the vehicle. EV battery housings protect a plurality of battery cells within the housing from exposure to water, dust, debris, and other elements as well as harsh external conditions. EV battery housings often include heat exchangers to cool the battery cells, which generate heat during use. Collectively, the plurality of battery cells and the housing can be referred to as a battery pack.

Protecting and cooling EV battery packs is challenging due to their location, size, and chemical makeup. Because EV battery packs are located on the undersides of vehicles, they can be exposed to water, dust, debris, and vibration. As such, EV battery packs must provide a barrier to harsh external conditions experienced by EV's.

However, one concern with battery packs is thermal management. Lithium-ion battery cells generate heat during use and, if this heat is not dispersed, the battery performance and life expectancy will be degraded. In some scenarios, overheating can lead to a short circuit where the heat will increase exponentially due to a phenomenon referred to as thermal runaway, causing catastrophic battery failure. As such, heat exchangers are built into battery housings in an effort to control or moderate thermal conditions. Typically, heat exchangers are constructed using a time and resource intensive process including preforming two or more metal plates by joining the plates together via brazing, which involves melting and flowing a filler metal into a joint. The brazing process requires specific design features to accommodate the filler metal, which has a lower melting point than the adjoining metal.

That said, there is a need for more efficient processes of manufacturing heat exchangers, processes that do not require preforming the panels, and processes that utilize more efficient bonding techniques such as welding. Of course welding, which does not require specific design features and does not utilize filler metal, is efficient and provides more robust bonds via melting of the panels and not just the filler material. Nonetheless, alternative processes such as those that employ welding may also present obstacles associated with the buildup of thermal stress in the metal, dimensional instability, and post construction issues associated with corrosion.

Considering the challenges above and the evolving strategies required to deal with the challenges, there remains a continued need for an improved heat exchangers for battery packs.

### SUMMARY

A heat exchanger including a plurality of cooling fluid circulation channels is disclosed. The heat exchanger comprises a first and a second panel. The first panel has an exterior surface and a channel surface opposite said exterior surface. The second panel has a cooling surface and an abutment surface opposite the cooling surface, the second panel is welded to the first panel via a network of channel seams. The plurality of cooling fluid circulation channels are defined by the channel surface of the first panel and the abutment surface of the second panel. Each of the plurality of cooling fluid circulation channels is disposed between a first and a second channel seam and defines a central flow cavity that narrows into a first and a second crevice as the first and the second panels converge at each of the first and the second channel seam, respectively. Each of the first and the second crevice has a length (L) and a width (W), and L²/W is less than 250.

A method of manufacturing a heat exchanger comprising a plurality of cooling fluid circulation channels is also disclosed. The method comprises the step of contacting a first panel and a second panel. Once the panels are contacted, a network of channel seams are welded between the first and second panels. The first and second panels with the network of channel seams therebetween are then deformed and flattened. Fluid is injected into the network of channel seams with the first and second panels clamped together to form the plurality of cooling fluid circulation channels. Each of the plurality of cooling fluid circulation channels is positioned between a first and a second channel seam and defines a central flow cavity that tapers into a first and a second crevice adjacent the first and the second channel seam. Fluid is then injected into the plurality of cooling fluid circulation channels to form the heat exchanger.

The step of welding provides robust bonds between the first and second panels, while the step of flattening and deforming reduces thermal stress in the first and second panels to provide dimensional stability. Further, the step of injecting fluid into the plurality of cooling fluid circulation channels to form the heat exchanger increases a width of each of the first and the second crevice to prevent crevice corrosion due to stagnation of cooling fluid in the first and the second crevices. These and other features of the disclosure will be more fully understood and appreciated by reference to the description of the examples and the drawings.

Before the examples of the disclosure are explained in detail, it is to be understood that the disclosure is not limited to the details of operation or to the details of construction and the arrangement of the components set forth in the following description or illustrated in the drawings. The disclosure may be implemented in various other examples and of being practiced or being conducted in alternative ways not expressly disclosed herein. In addition, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various examples. Unless otherwise expressly stated, the use of enumeration should not be construed as limiting the disclosure to any specific order or number of components. Nor should the use of enumeration be construed as excluding from the scope of the disclosure any additional steps or components that might be combined with or into the enumerated steps or components.

### BRIEF DESCRIPTION OF THE DRAWINGS

FIG. 1 is a top perspective view of an embodiment of the heat exchanger comprising a plurality of cooling fluid circulation channels described herein.

FIG. 2 is a cross-sectional view of a cooling fluid circulation channel at 2-2 of the heat exchanger in FIG. 1 at 2-2.

FIG. 2A is a partial cross-sectional view of a cooling fluid circulation channel of FIG. 2 illustrating a first example of crevice length and crevice width.

FIG. 2B is a partial cross-sectional view of a cooling fluid circulation channel of FIG. 2 illustrating a second example of crevice length and crevice width.

FIG. 3 is a cross-sectional view of crevice schematically illustrating crevice corrosion mechanics and resulting pitting.

FIG. 4 is a cross-sectional view of a crevice between two aluminum panels illustrating crevice corrosion after exposure to corrosive conditions.

FIG. 5 is a cross-sectional view of a crevice of an embodiment of a heat exchanger described herein before and after a step of injecting fluid into the plurality of cooling fluid circulation channels to increase a width (W) of the crevice to prevent crevice corrosion due to stagnation of cooling fluid in the crevice.

FIG. 6 is a cross-sectional view of a channel seam and a crevice of an embodiment of a heat exchanger described herein and a cross-sectional view of a channel seam and a crevice of an embodiment of a heat exchanger described herein with the channel seam positioned to reduce a length (L) of the crevice.

FIG. 7 is a flow chart describing an embodiment of a method of manufacturing a heat exchanger described herein.

FIG. 8 is a schematic diagram illustrating the transformation of a first panel and a second panel into a heat exchanger described herein.

FIG. 9 is a top perspective view of a first panel and a second panel contacted in a laser welding station in the form of a gantry with two moving laser heads in one plane that can be used to perform the step of welding a network of channel seams between the first panel and the second panel.

FIG. 10 is a side perspective view of a mobile laser head of the laser welding station of FIG. 9.

FIG. 11 is a side perspective view of a mobile laser head of FIG. 10 illustrating the formation of a channel seam with the movable mobile laser head.

FIG. 12 is a side perspective view of a roller system that can be used to perform a step of deforming and flattening a first and a second panel with the network of channel seams therebetween.

FIG. 13 is an isolated cross-sectional view of two of a plurality of cooling fluid circulation channels subsequent to a step of injecting fluid into a network of channel seams with a first and a second panel clamped together to form the plurality of cooling fluid circulation channels.

FIG. 14 is an isolated cross-sectional view of the two of a plurality of cooling fluid circulation channels of FIG. 13 subsequent to the step of injecting fluid into the plurality of cooling fluid circulation channels to increase a width (W) of crevices of the two of a plurality of cooling fluid circulation channels to prevent crevice corrosion due to stagnation of cooling fluid in the crevices.

FIG. 15 is an isolated cross-sectional view provided by an x-ray tomographic image is taken on two of a plurality of cooling fluid circulation channels subsequent to a step of injecting fluid into the plurality of cooling fluid circulation channels to increase a width (W) of crevices of the two of a plurality of cooling fluid circulation channels to prevent crevice corrosion due to stagnation of cooling fluid in the crevices.

### DETAILED DESCRIPTION

A heat exchanger and a method of manufacturing the heat exchanger is provided. While discussed below in connection with a battery heat exchanger for use in a battery housing in an electric vehicle (“EV”), the present method is suitable for a wide range of applications, inside and outside of EV applications, including applications such as heat exchangers for radiators and intercoolers.

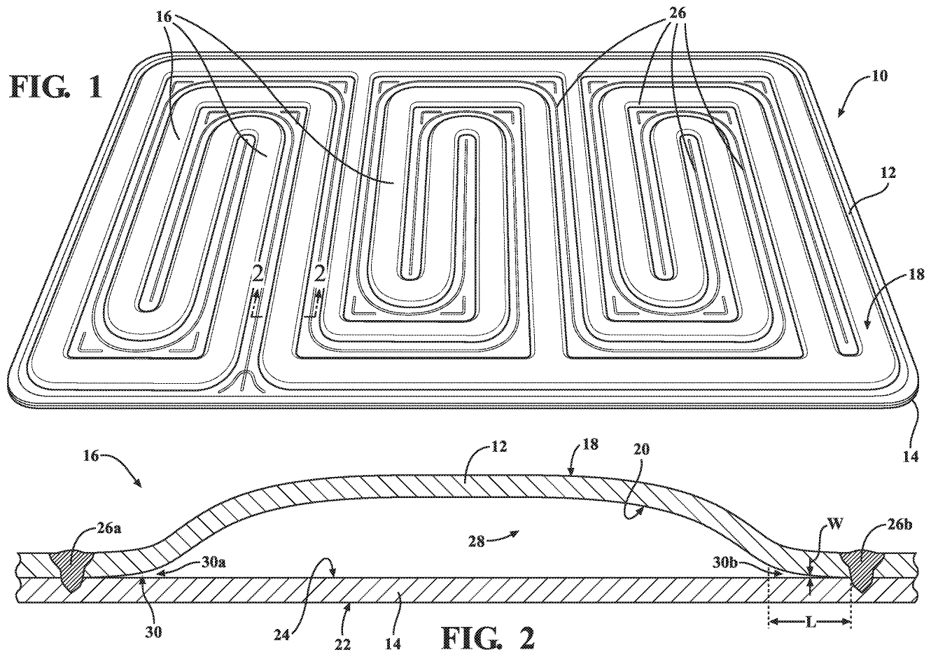

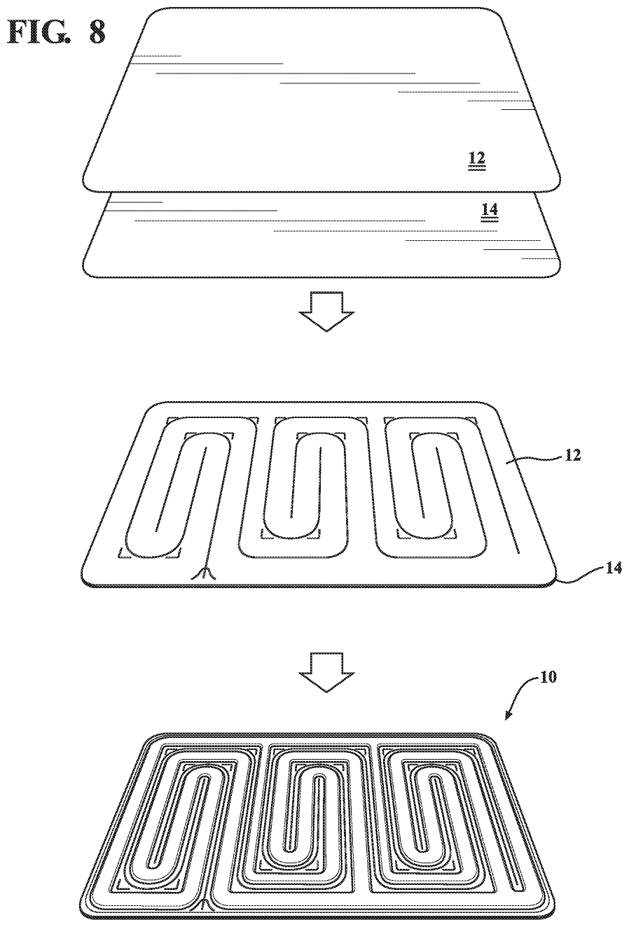

Referring to FIGS. 1-14, wherein like numerals indicate corresponding parts throughout the several views, the heat exchanger is illustrated and generally designated at 10. The heat exchanger 10 provides temperature control of a battery such as a Li battery included in a battery pack for an EV and is durable and corrosion resistant.

The heat exchanger 10 comprises a first panel 12 and a second panel 14 and includes a plurality of cooling fluid circulation channels 16. FIG. 1 is a top perspective view of an embodiment of the heat exchanger 10 which is described below.

The first panel 12 has an exterior surface 18 and a channel surface 20 opposite said exterior surface 18. The second panel 14 has a cooling surface 22 and an abutment surface 24 opposite the cooling surface 22, the second panel 14 is welded to the first panel 12 via a network of channel seams 26. The plurality of cooling fluid circulation channels 16 are defined by the channel surface 20 of the first panel 12 and the abutment surface 24 of the second panel 14.

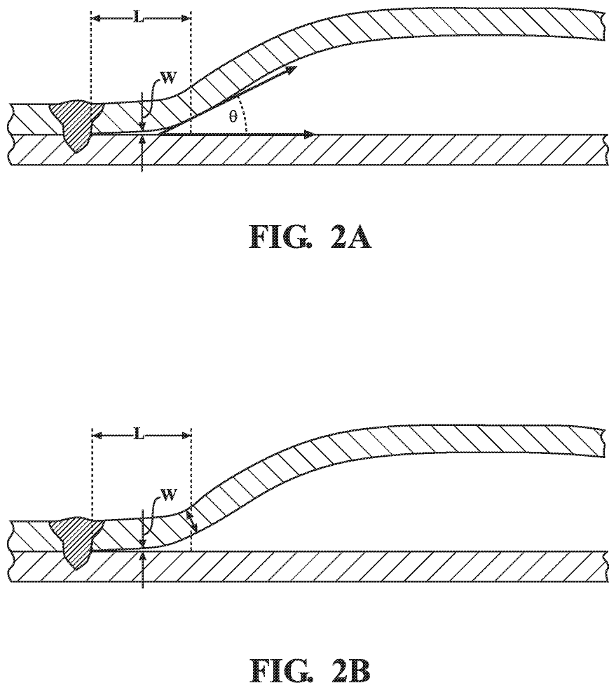

Referring now to FIG. 2, which is a cross-sectional view of one of the plurality of cooling fluid circulation channels 16 of the heat exchanger 10 illustrated in FIG. 1 at 2-2. As is illustrated, each of the plurality of cooling fluid circulation channels 16 is disposed between a first and a second channel seam 26a, 26b and defines a central flow cavity 28 that narrows into a first and a second crevice 30a, 30b as the first and the second panels 12, 14 converge at each of the first and the second channel seam 26a, 26b, respectively. Each of the first and the second crevice 30a, 30b extend from a first end to a second end. Length (L) for each crevice 30a, 30b is the distance from the first end of each respective crevice 30a, 30b the second end of each respective crevice 30a, 30b. In some embodiments, each of the first and the second crevice 30a, 30b have a width (W) measured at the midpoint of each respective crevice that is half-way between the first and second ends of each respective crevice 30a, 30b. In other embodiments, the width (W) of each of the first and the second crevice 30a, 30b can be defined as the average distance between the channel surface 20 of the first panel 12 and the abutment surface 24 of the second panel 14 over the length (L) of each respective crevice 30a, 30b.

Referring now to FIG. 2A, in a first embodiment, the first end of the crevice 30 is defined as point at which the weld seam 26 ends and the point at which the channel surface 20 of the first panel 12 and the abutment surface 24 of the second panel 14 cease to be welded together, i.e., the first point at which the channel surface 20 of the first panel 12 and the abutment surface 24 of the second panel 14 are not bonded or attached. In this first embodiment, the second end of the crevice 30 is defined as the point at which an angle (Θ) between a line tangent the channel surface 20 of the first panel 12 and the abutment surface 24 of the second panel 14 exceeds 25°. This second end of the crevice 30 is best illustrated in FIG. 2A. In additional alternative embodiments, the second end of the crevice 30 can be defined as the point at which an angle (Θ) between a line tangent the channel surface 20 of the first panel 12 and the abutment surface 24 of the second panel 14 exceeds 15, 16, 17, 18, 19, 20, 21, 22, 23, 24, 25, 26, 27, 28, 29, or 30°.

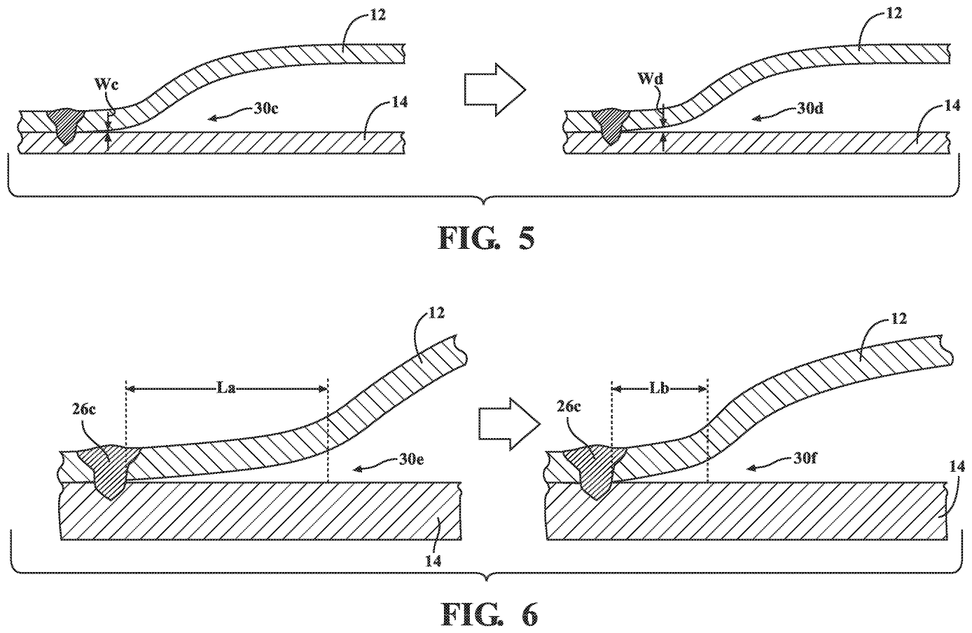

Referring now to FIG. 2B, in a second embodiment, the first end of the crevice 30 is defined as point at which the weld seam 26 ends (as described above) and the second end of the crevice 30 is defined as the point at which the stretched portion of the first panel 12 is thinnest. As is best illustrated in FIGS. 5 and 6, the first panel 12 stretches and thins as the first panel 12 is deformed during the step of forming the cooling fluid circulation channel 16 to leave a portion of the first panel 12 thinner than before formation of the cooling fluid circulation channel 16. In this embodiment of defining the second end of the crevice 30, a thickness the first panel 12 at this point less than the thickness of the first panel 12 on either side of this point and is thinnest in this stretched or thinned portion of the first panel 12. This second end of the crevice 30 is best illustrated in FIG. 2B.

In other embodiments, the length (L) of the crevice 30 is simply defined as 4, 5, 6, 7, or 8 mm starting at the first end of the crevice 30 (defined as point at which the weld seam 26 ends) and extending out 4, 5, 6, 7, or 8 mm. Just as described above, the width (W) of the crevice 30 is the width at the midpoint of the crevice. In these embodiments, the width can be measured at a distance of 2, 2.5, 3, 3.5, and 4 mm from the first end of the crevice, respectively or can be the average distance between the channel surface 20 of the first panel 12 and the abutment surface 24 of the second panel 14 over the length (L) of the crevice 30.

In many embodiments, the length (L) of the crevice 30 in mm and the width (W) of the crevice 30 in mm (as defined above) can be used to estimate the likelihood for crevice corrosion. More specifically, the following calculation can be used:

$$Crevice Corrosion Factor = {L}^{2} / W$$

In many embodiments, the Crevice Corrosion Factor (L²/W) is less than about 250, about 225, about 200, or about 175. The lower the Crevice Corrosion Factor (L²/W) is the less likely corrosion is to occur. In a preferred embodiment, L²/W is less than about 200. As a first example, corrosion is likely to occur in a crevice having a length (L) of 5 mm and a width (W) of 0.05 mm with a Crevice Corrosion Factor (L²/W) of 500. As a second example, corrosion is unlikely to occur in a crevice having a length (L) of 5 mm and a width (W) of 0.5 mm with a Crevice Corrosion Factor (L²/W) of 50.

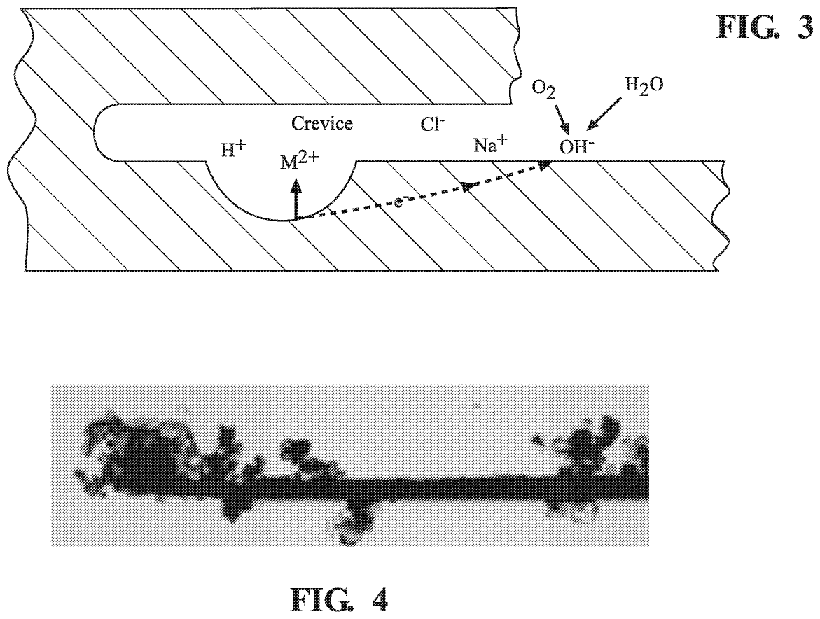

FIGS. 3 and 4 illustrate corrosion of aluminum upon exposure to an NaCl solution. FIG. 3 is a cross-sectional view of crevice 30 schematically illustrating crevice corrosion mechanics and resulting pitting which can occur during corrosion. FIG. 4 is an actual cross-sectional image of crevice 30 between two aluminum panels illustrating crevice corrosion after exposure to corrosive conditions.

The design of the subject heat exchanger 10 prevents crevice corrosion by controlling the (L) and the width (W) of the crevices 30 of the plurality of cooling fluid circulation channels 16. FIG. 5 is a cross-sectional view of a crevice 30c before and the crevice 30d after a step of injecting fluid into the plurality of cooling fluid circulation channels 16 to increase the width (W) of the crevice 30d to prevent crevice corrosion due to stagnation of cooling fluid in the crevice 30d. The fluid is injected and pressure within the cooling fluid circulation channels 16 is increased to accomplish increase in crevice width. In the example of FIG. 5, width (Wc) is less than width (Wd). In most embodiments, when width (W) increases, L²/W decreases, which deters stagnation of cooling fluid and corrosion.

FIG. 6 is a cross-sectional view of the channel seam 26c and the crevice 30e of an embodiment of a heat exchanger described herein and a cross-sectional view of a channel seam 26c and a crevice 30f of an embodiment of the heat exchanger 10 described herein with the channel seam 26c positioned to reduce the length (L) of the crevice 30. In this non-limiting example of FIG. 6, length (La) is greater than length (Lb). In most embodiments, when length (L) increases, L²/W increases, which can contribute to stagnation of cooling fluid and corrosion. It should be noted that this is an optional design adjustment or step that is not always included in the heat exchanger and method disclosed herein. From a cost perspective, in many embodiments the amount of laser welding is minimized by positioning the channel seam 26 midway between cooling fluid circulation channels 16 (e.g. midway between a center point of each of two cooling fluid circulation channels 16), which results in a relatively long length (L). Generally, the channel seam 26 is a distance of from about 1 to 10 or about 2 to 3 mm from the edge of the fluid circulation channel 26/end of the crevice 30.

The first and second panels 12, 14 typically comprise a weldable metal or metal alloy. In a preferred embodiment, the first and second panels 12, 14 typically comprise aluminum or an aluminum alloy that is durable but malleable. Of course, the first panel 12, which is typically deformed in the process of manufacturing the heat exchanger described herein can comprise a first type of aluminum or aluminum alloy and the second panel 14, which is typically minimally deformed or not deformed in the process of manufacturing the heat exchanger described herein (“the manufacturing process”) can comprise a second type (or a different type) of aluminum or aluminum alloy.

Prior to manufacturing the heat exchanger 10, the first and second panels 12, 14 are typically planer or flat. In many embodiments, the first panel 12 typically has a thickness of from about 0.3 to 10 mm, from about 0.4 to 5 mm, or from about 0.5 to 2 mm prior to the manufacturing process. It should be appreciated that the manufacturing process may decrease the thickness of the first panel 12 in areas where deformation of the first panel 12 occurs during the formation of plurality of cooling fluid circulation channels 16. In many embodiments, the second panel 14 typically has a thickness of from about 0.4 to 8 mm or from about 0.8 to 4 mm prior to the manufacturing process. It should be appreciated that the manufacturing process may decrease the thickness of the second panel 14 in areas where deformation of the second panel 14 occurs (if the second panel 14 is deformed) during the formation of a plurality of cooling fluid circulation channels 16. In the preferred embodiment of the heat exchanger 10, the first panel 12 is deformed to define a cross-sectional profile and a path of the plurality of cooling fluid circulation channels 16 while the cooling surface 22 and said abutment surface 24 of the second panel 14 remain substantially planer. In various non-limiting examples, 3xxx and 5xxx grade aluminum alloys can be used to fabricate the first and second panels 12, 14. Such alloys tend to be readily weldable with autogenous laser welding.

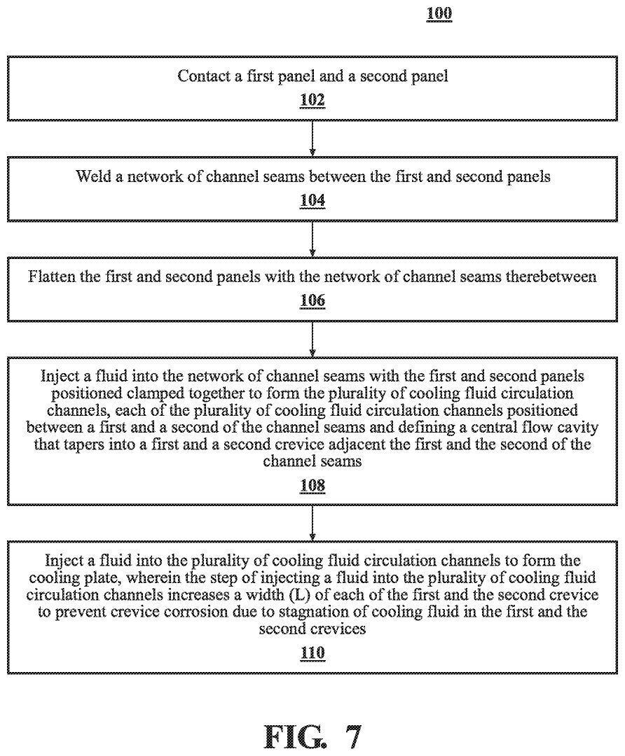

Referring now to FIG. 7, a method 100 of manufacturing the heat exchanger 10 comprising the plurality of cooling fluid circulation channels 16 is also disclosed. The method 100 comprises the steps of: contacting 102 the first panel 12 and the second panel 14; welding 104 the network of channel seams 26 between the first and second panels 12, 14; deforming and flattening 106 the first and second panels 12, 14 with the network of channel seams 26 therebetween; injecting fluid 108 into the network of channel seams 26 with the first and second panels 12, 14 clamped together to form the plurality of cooling fluid circulation channels 16, each of the plurality of cooling fluid circulation channels 16 positioned between the first and the second channel seam 26a, 26b and defining the central flow cavity 28 that tapers into the first and the second crevice 30a, 30b adjacent the first and the second channel seam 26a, 26b; and injecting fluid 110 into the plurality of cooling fluid circulation channels 16 to form the heat exchanger 10. The step of injecting fluid 110 into the plurality of cooling fluid circulation channels 16 increases the width (W) of each of the first and the second crevice 30a, 30b to prevent crevice corrosion due to stagnation of cooling fluid in the first and the second crevices 30a, 30b. The crevices 30 of the plurality of cooling fluid circulation channels 16 have a length (L) and the width (W) and the step of injecting a fluid into the plurality of cooling fluid circulation channels 16 increases the width so that L²/W is less than about 250, about 225, about 200, or about 175.

As set forth above, the method 100 comprises the step of contacting 102 a first panel and a second panel. Once the first and second panels 12, 14 are contacted, the network of channel seams 26 are welded between the first and second panels 12, 14. The step of welding 104 can be further defined as laser welding the network of channel seams 26. In some embodiments of the method 100, the step of welding 104 can be conducted with at least two laser beams (2 or more). That is so the step of welding 104 can be conducted with multiple laser beams (2, 3, 4, 5, 6, etc.).

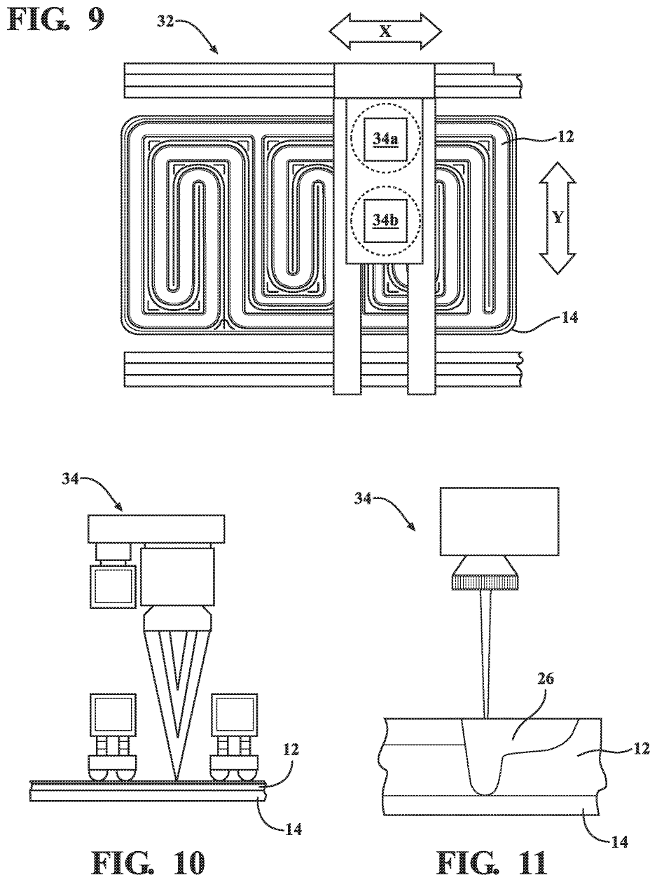

Referring now to FIGS. 9, 10, and 11, the step of welding 104 can be accomplished via welding the first and second panels 12, 14 with laser. An autonomous welding system utilizing remote controls can be used to weld the network of channel seams 26 at high speed. Alternatively, a laser head mounted on a robotic arm can be used to weld the network of channel seams 26. Welding parameters such as energy density and positional focus of the laser beam can be adjusted to create channel seams having a width of from about 0.4 to about 2.0 or about 0.7 to about 1.0 mm. The network of channel seams 26 should be formed with high power and speed for manufacturing efficiency. For example, power of greater than about 1 kW and speeds greater than about 6 m/min can be utilized. In some embodiments, the channel seams should be welded at a speed of from about 8 to about 30 or about 10 to about 20 m/min.

Referring specifically to FIG. 9, a top perspective view of the first panel and the second panel contacted in a laser welding station 32 in the form of a gantry with two moving laser heads 34a and 34b in one plane that can be used to perform the step of welding the network of channel seams 26 between the first panel 12 and the second panel 14 is illustrated. FIG. 10 provides a side perspective view of a mobile laser head 34 of the laser welding station 32 of FIG. 9. FIG. 11 is a side perspective view of the mobile laser head 34 of FIG. 10 illustrating the formation of one of the plurality of channel seams 26 with the movable mobile laser head 34.

The method may include the step of contacting 102 the first and second panels via the application of pressure adjacent a planned channel seam during the step of welding 104. That is, during the step of welding 104, the first and second panels 12, 14 can be pressed against one another via a clamping means synchronistically applied with, i.e., that move with, the laser. Of course all of the areas adjacent the channel seams can be contacted while the channel seams are welded such that the clamping does not move with the laser beam(s). In some embodiments, the step of welding 104 starts in a central region of the first and second panels 12, 14 and gradually progresses towards a periphery of the first and second panels 12, 14 with one or more laser beams.

The step of contacting 102 the first and second panels during the step of welding 104 can be further defined as clamping via vacuum suction and pressing the first and second panels together. The step of contacting 102 reduces the buildup of stress in and between the first and second panels 12, 14 and the formation of interstices and other weld defects that result from thermal expansion by the intense, localized application of energy via the laser. Of course, the buildup of stress in and between the first and second panels 12, 14 and the formation of interstices and other weld defects can also be reduced through a step of cooling the first and/or the second panel during the step of welding 104.

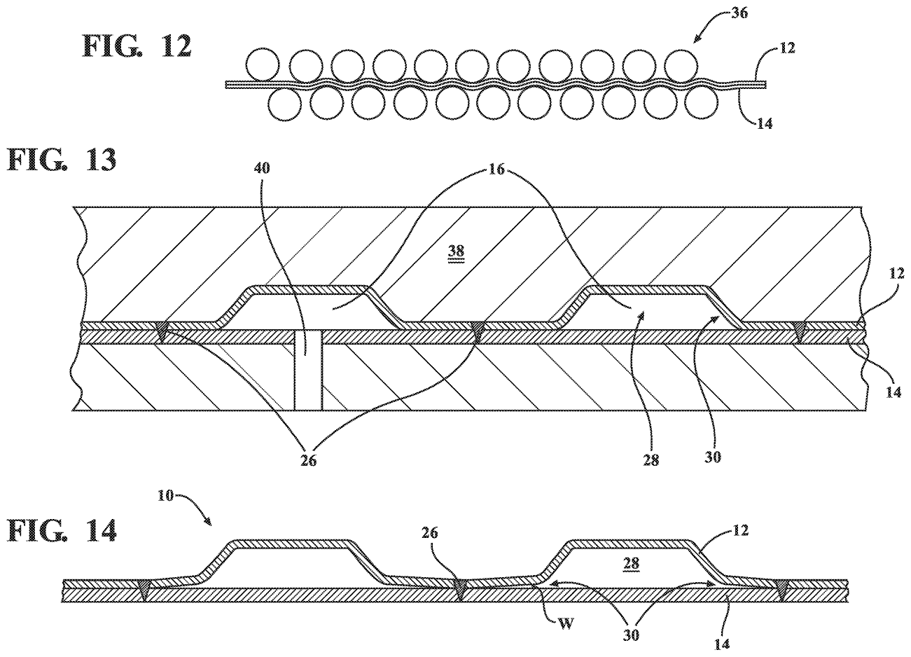

After the step of welding 104, the first and second panels 12, 14 with the network of channel seams 26 therebetween are then flattened. As is illustrated in FIG. 12, the step of flattening 106 may be conducted via rolling. The step of flattening 106 (1) deforms and flattens the first and second panels 12, 14 with the network of channel seams 26 therebetween; (2) removes surface irregularities and defects from the exterior surface 18 of the first panel 12 and the cooling surface 22 of the second panel 14; and, importantly, (3) releases stress or tension that builds in the first and second panels during the step of welding 104.

The step of flattening 106 may include one or more passes through a series of rollers 36 on a roll leveler. A roll leveler progressively deforms and flattens the first and second panels, as is illustrated in FIG. 12. Still referring to FIG. 12, as the first and second panels progress through the series of rollers of the roll leveler bending is more severe at the onset but becomes progressively less severe as the panels progress through the rollers. This series or sequence of deformations and flattening is accomplished via roller positioning and spacing (not specifically illustrated). In some embodiments, the top rollers are positioned deeper in the offset between bottom rollers at the start of the series of rollers of the roll leveler (thus the panels are bent more severely) and the top rollers are positioned slightly in the offset between bottom rollers at the end of the series of rollers of the roll leveler (thus the panels are bent less severely). In some embodiments, at least two successive passes through the series of rollers, which are conducted in different orientations. That is, the different passes (one or more) may be oriented between 30° and 90° relative to each other. Alternatively, the step of deforming and flattening comprises at least two passes through the series of rollers 36, each of at least two passes conducted at an orientation of from about 30° to about 90° different relative to the series of rollers 36.

After the step of flattening 106, fluid is injected into the network of channel seams 26 with the first and second panels 12, 14 clamped together to form (e.g. hydroform) the plurality of cooling fluid circulation channels 16. Each of the plurality of cooling fluid circulation channels 16 is positioned between a first and a second channel seam 26a, 26b and defines the central flow cavity 28 that tapers into a first and a second crevice 30a, 30b adjacent the first and the second channel seam 26a, 26b. The step of injecting fluid 108 into the network of channel seams 26 may be conducted at a first fluid pressure of from about 4 to about 50, or about 6 to about 30 MPa. Specific fluid pressures adapted to the method 100 depend on the thickness of the panels, the grade of metal/aluminum, and the shape of the plurality of cooling fluid circulation channels 16. In some embodiments, the first fluid pressure is achieved gradually, as fluidic pressure can be slowly increased, pulsed, pulsed increasingly, and varied to ultimately reach the first fluid pressure while minimizing stress on the first and second panels and the weld seems therebetween.

Typically the first and second panels 12, 14 are clamped together during the step of injecting fluid 108 into the network of channel seams 26. In some embodiments, pressure is exerted on the first panel 12 in areas outside of the network of channel seams 26 to maintain contact between the first and second panels 12, 14 in these areas to maintain flatness and reduce stress in the areas outside of the network of channel seams 26 of the heat exchanger 10 while allowing deformation of the first and/or the second panel within the network of channel seams 26 and thus formation of the plurality of cooling fluid circulation channels 16. In such embodiments, pressure can be selectively or uniformly exerted across the cooling surface of the second panel.

Referring now to FIG. 13, in many embodiments, the first and second panels 12, 14 are clamped together and under pressure in a mold 38. That is, the step of injecting fluid 108 into the network of channel seams 26 is conducted with the first and second panels 12, 14 positioned in the mold 38. In such embodiments, formation of the plurality of cooling fluid circulation channels 16 under hydraulic pressure occurs when the first panel 12 is deformed into a cavity shaped to define the cross-sectional profile of the plurality of cooling fluid circulation channels 16. The first panel 12, typically comprises Al or an Al alloy that is malleable and deforms because of the internal pressure exerted within the network of channel seams 26. Each of the plurality of cooling fluid circulation channels 16 are formed between two corresponding channel seams and extend between corresponding channel seams 26 with crevices 30 adjacent to the corresponding channel seams and the central flow cavity 28 therebetween.

Still referring to FIG. 13, the isolated cross-sectional view of two of a plurality of cooling fluid circulation channels 16 subsequent to the step of injecting fluid 108 into the network of channel seams 26 with the first and second panels 12, 14 clamped together to form the plurality of cooling fluid circulation channels 16 is illustrated. A fluid injection port 40, for injecting fluid between the two panels 12, 14 is also illustrated in FIG. 13. As more specifically illustrated in FIG. 13, it is advantageously provided that, during the progress of the step of forming the plurality of cooling fluid circulation channels 16 by injecting fluid 108 (which can be liquid or gas) into the network of channel seams 26 between the first and second panels 12, 14 the mold provides a boundary into which the first panel is deformed and thus prevents unnecessary thinning and stretching of the first panel 12 and ultimately provides consistent first panel thickness and cooling fluid circulation channel shape. Once the plurality of cooling fluid circulation channels 16 are formed, the fluid injected into the network of channel seams 26 is released and the heat exchanger 10 can be remove from the mold.

As is described above, each of the plurality of cooling fluid circulation channels 16 formed is positioned between a first and a second channel seam 26a, 26b and defines the central flow cavity 28 that tapers into the first and a second crevice 30a, 30b adjacent the first and the second channel seam 26a, 26b. The crevices 30 formed, e.g., the first and a second crevice 30a, 30b adjacent the first and the second channel seam 26a, 26b an area cooling fluid to stagnate and thus provide the potential for crevice corrosion.

To this end, the method 100 includes a final step wherein fluid is then injected into the plurality of cooling fluid circulation channels 16 to increase a width (W) of each of the first and the second crevice 30a, 30b to prevent crevice corrosion due to stagnation of cooling fluid in the first and the second crevices 30a, 30b. As is explained above, each of the first and the second crevice 30a, 30b has a length (L) and a width (W) and L²/W is less than about 250, about 225, about 200, or about 175. The lower L²/W is the less likely corrosion is to occur. In a preferred embodiment, L²/W is less than about 200.

In many embodiments, the step of injecting a fluid into the network of channel seams and/or the step of injecting fluid into the plurality of cooling fluid circulation channels is conducted with the first and second panels positioned in a mold or molds. In a preferred embodiment of the method 100 the mold is opened and the heat exchanger 10 is left in the mold. To this end, the step of injecting a fluid into the network of channel seams and the step of injecting fluid into the plurality of cooling fluid circulation channels is conducted with the first and second panels positioned in a single mold. The fluid is released from the plurality of cooling fluid circulation channels. Fluid is then used to pressurize the plurality of cooling fluid circulation channels. The step of injecting fluid 110 into the plurality of cooling fluid circulation channels 16 may be conducted at a second fluid pressure of from about 0.5 to about 10, or about 2 to about 6 MPa.

The step of injecting fluid 110 into the plurality of cooling fluid circulation channels 16 may be conducted outside of a mold. However, in many embodiments, the step of injecting fluid 110 into the plurality of cooling fluid circulation channels 16 is conducted in a mold as described above. In some embodiments, the mold comprises at least a first and a second piece and the step of injecting fluid into the plurality of cooling fluid circulation channels is conducted with the first and second panels of the first and the second piece of the mold separated. For example, the step of injecting fluid 110 into the plurality of cooling fluid circulation channels can be conducted with the first and the second piece of the mold separated by a distance of from about 0.5 to about 8 mm or from about 1 to about 5 mm. In other embodiments, the step of injecting fluid 110 into the plurality of cooling fluid circulation channels can be conducted with the first and the second piece of the mold together (not separated), but the clamping force on the first and the second piece of the mold reduced.

The step of injecting fluid 110 into the plurality of cooling fluid circulation channels 16 is typically conducted at a second fluid pressure that is lower than the first fluid pressure which is injected into the network of channel seams 26. In some embodiments, the second fluid pressure is achieved gradually, as fluidic pressure can be slowly increased, pulsed, pulsed increasingly, and varied to ultimately reach the second fluid pressure in order to achieve a desired crevice separation that minimizes corrosion while minimizing stress on the first and second panels and channel seam 26s.

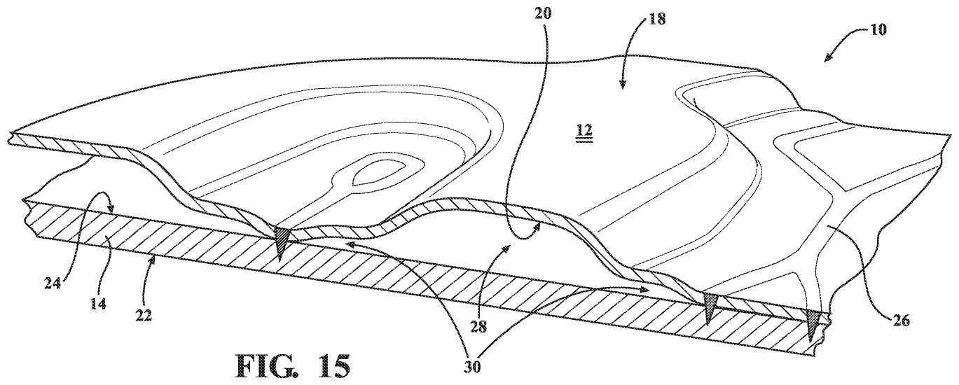

FIG. 14 is an isolated cross-sectional view of the two of a plurality of cooling fluid circulation channels 16 subsequent to the step of injecting fluid 110 into the plurality of cooling fluid circulation channels 16 increases which a width (W) of crevices 30 of the two of a plurality of cooling fluid circulation channels 16 to prevent crevice corrosion due to stagnation of cooling fluid in the crevices. In FIG. 14, the previously narrow widths illustrated in FIG. 13 are wider, so that crevice corrosion can be avoided. In FIG. 15 a drawing illustrating an isolated cross-sectional view provided by an x-ray tomographic image taken on two of the plurality of cooling fluid circulation channels 16 subsequent to a step of injecting fluid into the plurality of cooling fluid circulation channels 16 to increase a width (W) of crevices of the two of a plurality of cooling fluid circulation channels to prevent crevice corrosion due to stagnation of cooling fluid in the crevices 30 is presented.

The above description is that of current examples of the disclosure. Various alterations and changes can be made without departing from the spirit and broader aspects of the disclosure as defined in the appended claims, which are to be interpreted in accordance with the principles of patent law including the doctrine of equivalents. This disclosure is presented for illustrative purposes and should not be interpreted as an exhaustive description of all examples of the disclosure or to limit the scope of the claims to the specific elements illustrated or described in connection with these examples. For example, and without limitation, any individual element(s) of the described disclosure may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed examples include a plurality of features that are described in concert and that might cooperatively provide a collection of benefits. The present disclosure is not limited to only those examples that include all these features or that provide all the stated benefits, except to the extent otherwise expressly set forth in the issued claims. Any reference to claim elements in the singular, for example, using the articles “a,” “an,” “the” or “said,” is not to be construed as limiting the element to the singular.

1. A heat exchanger for a battery housing comprising a plurality of cooling fluid circulation channels, the heat exchanger comprising:
a first panel having an exterior surface and a channel surface opposite said exterior surface;
a second panel having a cooling surface and an abutment surface opposite the cooling surface, the second panel welded to the first panel via a network of channel seams; and
the plurality of cooling fluid circulation channels are defined by the channel surface of the first panel and the abutment surface of the second panel, with each of the plurality of cooling fluid circulation channels disposed between a first and a second channel seam and defining a central flow cavity that narrows into a first and a second crevice as the first and the second panels converge at each of the first and the second channel seam, respectively;
wherein each of the first and the second crevice has a length (L) and a width (W), and L²/W is less than 250.

2. The heat exchanger as set forth in claim 1, wherein the first panel and/or the second panel comprises aluminum or an aluminum alloy.

3. (canceled)

4. The heat exchanger as set forth in claim 32, wherein the first panel defines a cross-sectional profile and a path of the plurality of cooling fluid circulation channels.

5. A method of manufacturing a heat exchanger comprising a plurality of cooling fluid circulation channels, said method comprising the steps of:
contacting a first panel and a second panel;
welding a network of channel seams between the first and second panels;
deforming and flattening the first and second panels with the network of channel seams therebetween;
injecting fluid into the network of channel seams with the first and second panels clamped together to form the plurality of cooling fluid circulation channels, each of the plurality of cooling fluid circulation channels positioned between a first and a second channel seam and defining a central flow cavity that tapers into a first and a second crevice adjacent the first and the second channel seam; and
injecting fluid into the plurality of cooling fluid circulation channels to form the heat exchanger,
wherein the step of injecting fluid into the plurality of cooling fluid circulation channels increases a width (W) of each of the first and the second crevice to prevent crevice corrosion due to stagnation of cooling fluid in the first and the second crevices.

6. The method of claim 5, wherein each of the first and the second crevice has a length (L) and the width (W) and the step of injecting a fluid into the plurality of cooling fluid circulation channels increases the width so that L²/W is less than 250.

7. The method of claim 5, further comprising the step of releasing the fluid injected into the network of channel seams.

8. The method of claim 5, wherein the step of injecting a fluid into the network of channel seams is conducted at a first fluid pressure from about 4 to about 50 MPa.

9. The method of claim 8, wherein the step of injecting a fluid into the plurality of cooling fluid circulation channels is conducted at a second fluid pressure of from about 0.5 to about 10 MPa with the second fluid pressure being lower than the first fluid pressure.

10. The method of claim 5, wherein the step of injecting a fluid into the network of channel seams and/or the step of injecting fluid into the plurality of cooling fluid circulation channels is conducted with the first and second panels positioned in a mold.

11. (canceled)

12. The method of claim 10, wherein the step of injecting a fluid into the network of channel seams and the step of injecting fluid into the plurality of cooling fluid circulation channels are conducted with the first and second panels in the mold.

13. The method of claim 12, wherein the mold comprises at least a first and a second piece and the step of injecting fluid into the plurality of cooling fluid circulation channels is conducted with the first and the second piece of the mold separated.

14. The method of claim 13, wherein the first and the second piece of the mold are separated by a distance of from 0.5 to 8 mm.

15. The method of claim 5, wherein the step of deforming and flattening is conducted by sequentially deforming and flattening panels with a roll leveler.

16. The method of claim 15, wherein the step of rolling comprises at least two passes through a plurality of rollers, each of at least two passes conducted at an orientation of from about 30° to about 90° different relative to the plurality of rollers.

17. (canceled)

18. The method of claim 5, wherein the step of welding is conducted with at least two laser beams, and/or the first and/or the second panel are cooled during the step of welding.

19. The method of claim 5, wherein the first and second panels are contacted via application of pressure adjacent a planned channel seam during the step of welding.

20. The method of claim 5, wherein the step of contacting is further defined as clamping via vacuum suction and pressing the first and second panels together.

21. (canceled)

22. The method of claim 20, the step of forming the plurality of cooling fluid circulation channels is conducted with the first and second panels in a mold that exerts pressure on the first and second panels in areas outside of the network of channel seams.

23. The method of claim 5, wherein the step of injecting a fluid into the network of channel seams with the first and second panels clamped together is further defined as exerting pressure on the first panel in areas outside of the network of channel seams to maintain contact between the first and second panels in these areas to maintain flatness and reduce stress in the areas outside of the network of channel seams of the heat exchanger while allowing deformation of the first and/or the second panel within the network of channel seams and thus formation of the plurality of cooling fluid circulation channels.

24. The method of claim 23, wherein the step of injecting fluid into the network of channel seams with the first and second panels clamped together is further defined as exerting pressure uniformly across a cooling surface of the second panel.
